(19) United States
(12) Patent Application Publication
(10) Pub. No.: US 2025/0004736 A1
(43) Pub. Date: Jan. 2, 2025

(54) GENERATING PROGRAM BINARIES FOR A TRANSFORMER TO PROCESS SEQUENCE CONCATENATIONS HAVING DIFFERENT INPUT LENGTHS

(71) Applicant: INTERNATIONAL BUSINESS MACHINES CORPORATION, Armonk, NY (US)

(72) Inventors: Swagath Venkataramani, White Plains, NY (US); Sanchari Sen, White Plains, NY (US); Amrit Nagarajan, West Lafayette, IN (US); Vijayalakshmi Srinivasan, New York, NY (US); Sarada Krithivasan, White Plains, NY (US)

(21) Appl. No.: 18/344,487

(22) Filed: Jun. 29, 2023

(51) Int. Cl. G06F 8/52

(52) U.S. Cl. CPC G06F 8/52

(57) ABSTRACT

Provided are a computer program product, system, and method for generating program binaries for a transformer to process sequence concatenations having different input lengths. A sequence concatenation length is selected of a sequence concatenation of concatenated tokens from inputs to process in the accelerator. A determination is made of combinations of input lengths. A representation of a transformer is processed to generate program binaries for each combination of input lengths of the combinations. The program binaries, for a given combination of input lengths of the combinations, program the accelerator to decompose tokens of inputs in the sequence concatenation according to the input lengths in the given combination and compute attention scores between tokens within each input of the inputs in the sequence concatenation. The program binaries, for a combination of input lengths, are executed to process a sequence concatenation of received inputs to generate outputs.

### BACKGROUND

### 1. Field of the Invention

The present invention relates to a computer program product, system, and method for generating program binaries for a transformer to process sequence concatenations having different input lengths.

### 2. Description of the Related Art

Artificial intelligence (AI) applications include language transformers to perform natural language processing (NLP) on text inputs received from clients at an inference server. A language transformer may include an embedding layer, followed by multiple transformer layers (Feed-forward neural networks, layer norms, and multi-headed self-attention layers, and then a task-specific final layer. Language transformers may have billions of parameters, which poses substantial computational and storage challenges.

To address the high computational costs, specialized hardware devices known as AI accelerators have been developed to process offloaded AI workloads. An AI accelerator has an array of processing elements (PEs) supporting computations to execute convolution and matrix multiplication operations. The AI accelerator loads weights and biases of a neural network onto the array of PEs to use to process text input to generate the desired NLP output, such as a classification of the text input or a response or answer when the text input comprises a question or request. The neural network weights and biases remain static in the PEs and are used to process multiple inferences, or AI jobs.

Text input for a language transformer often has different sequence lengths. The tokens for text inputs may be batched and then fed into the language transformer. To batch the text input having different lengths of tokens, tokens may be padded so that the tokens and padding for each text input have the same length.

### BRIEF DESCRIPTION OF THE DRAWINGS

Referring now to the drawings in which like reference numbers represent corresponding parts throughout:

FIG. 1 illustrates an embodiment of an inference server having an AI accelerator.

FIG. 2 illustrates an embodiment of the AI accelerator having a language transformer.

FIG. 3 illustrates an embodiment of an AI accelerator chip in which the AI accelerator is implemented.

FIG. 4 illustrates an embodiment of a core on the AI accelerator chip comprised of an array of processing elements.

FIG. 5 illustrates an example of how text inputs are concatenated into a single vector.

FIG. 6 illustrates an example of matrices used in the language transformer having dimensions of the sequence concatenation length and a dimension of a hidden layer of calculations for calculating attention scores.

FIG. 7 illustrates an example of matrix multiplication to calculate attentions scores.

FIG. 8 illustrates an embodiment of operations to compile program binaries for concatenation sequences having text inputs of different lengths.

FIG. 9 illustrates an embodiment of operations to concatenate text inputs for the language transformer.

FIG. 10 illustrates an embodiment of operations to calculate attention scores.

FIG. 11 illustrates a computing environment in which the components of FIG. 1 may be implemented.

### SUMMARY

Provided are a computer program product, system, and method for generating program binaries for a transformer to process sequence concatenations having different input lengths. A sequence concatenation length is selected of a sequence concatenation of concatenated tokens from inputs to process in the accelerator. A determination is made of combinations of input lengths. Each combination of input lengths sum to the sequence concatenation length. A representation of a transformer is processed to generate program binaries for each combination of input lengths of the combinations. The program binaries, for a given combination of input lengths of the combinations, program the accelerator to decompose tokens of inputs in the sequence concatenation according to the input lengths in the given combination and compute attention scores between tokens within each input of the inputs in the sequence concatenation. The program binaries, for a combination of input lengths, are executed to process a sequence concatenation of received inputs, having input lengths of the combination, to generate outputs for tokens in the processed sequence concatenation.

### DETAILED DESCRIPTION

In current implementations, when tokens from different text inputs are padded, the language transformer will perform numerous computations on padded tokens, which results in wasteful computations and loss when processing batched text inputs. Described embodiments provide improvements to computer technology for batching text inputs for a language transformer by allowing different length text inputs to be concatenated in a sequence concatenation. The compiler may generate program binaries for different combinations of text input lengths to batch text inputs and allow for processing of the concatenated sequence having text input lengths for which the combinations were generated without padding. This provides substantial improvement in efficiency of computations of the language transformer by allowing batching of text inputs to maximize throughput and at the same time avoid wasting computations by eliminating padding for the most common text input lengths, and minimizing padding for text input lengths not specified for the combinations of text input lengths for which the program binaries are generated.

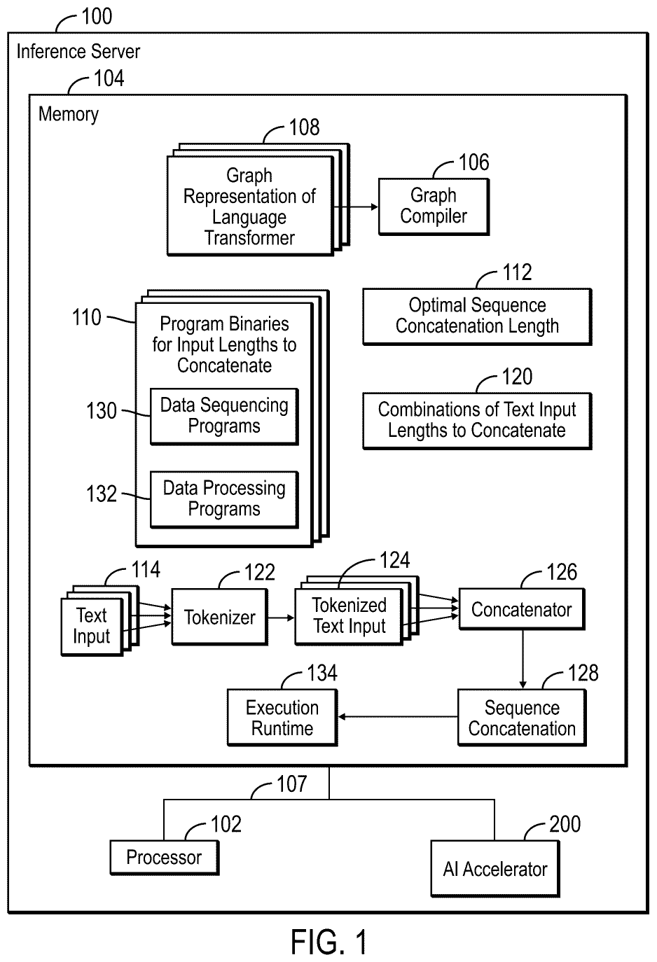

FIG. 1 illustrates an embodiment of an inference server 100 having a processor 102, having one or more cores, a memory 104, and an artificial intelligence (“AI”) accelerator 200 to process text inputs to subject to a natural language processor (NLP) transformer. The components 102, 104, and 200 may communicate over a bus interface 107, such as a Peripheral Component Interconnect Express (PCIe) bus.

The inference server 100 may be utilized in a server or enterprise system to provide dedicated on-chip AI acceleration. The AI accelerator 200 may comprise an on-chip AI accelerator that enables generating real-time insights from inferences, each inference having input data for which an inference output is to be generated. For an NLP transformer, the output may comprise a classification of text inputs or a response to text input comprising a question or a request/command. The AI accelerator 200 provides consistent low latency and high throughput (e.g., over 200 TFLOPS in 32 chip system) inference capacity usable by all threads. The AI accelerator 200 is memory coherent and directly connected to the fabric like other general-purpose core to support low latency inference while meeting the system's transaction rate. A scalable architecture providing transparent access to AI accelerator functions via a non-privileged general-purpose core instruction further reduces software orchestration and library complexity as well as provides extensibility to the AI functions.

The memory 104 includes a graph compiler 106 that receives as input a graph representation of a language transformer neural network model 108, such as in a high-level framework, e.g., PyTorch, TensorFlow, etc. The compiler 106 automatically identifies how best to execute a given neural network graph for the language transformer 108 on the AI accelerator 200 and constructs the program binaries 110 to load weights and biases, and execute the language transfer graph 108. The graph compiler 106 determines an optimal sequence concatenation length 112 for the language transformer 108 at which tokens from multiple text inputs 114 for different inference jobs may be combined. The optimal sequence concatenation length 112 may comprise an optimal number of tokens in the sequence concatenation 128. The optimal length 112 may comprise the maximum length, or number of tokens, at which the latency to complete generating the inference output can satisfy a latency constraint. This optimal sequence concatenation length 112 maximizes throughput and maintains a required latency. The graph compiler 106 may generate an optimal set of weights and biases for the optimal sequence concatenation length 112 for the sequence-parallel computations. The graph compiler 106 may also determine combinations of text input lengths 120 to concatenate that sum to the optimal sequence concatenation length 112. A text input length may comprise a number of tokens in an instance of text input 114. For instance, if the optimal sequence concatenation length 112 comprises 100 tokens, then the combinations may include, by way of example, text input lengths, i.e., number of tokens, of 25 and 75; 25, 25, and 50, etc. Alternatively, the length may comprise a size, e.g., number of bytes, of the tokens.

The combinations of text input lengths 120 may comprise the most commonly received text input lengths, i.e., number of tokens, based on a distribution of text input lengths gathered during inference operations or from a training set.

The memory 104 further includes a tokenizer 122 that receives text inputs 114 comprising sentences or phrases of words and tokenizes the words of the text input 114 into tokenized text input 124. A concatenator 126 attempts to combine the tokenized text inputs 124 having text input lengths specified for one of the combinations 120 into a single sequence concatenation 128 comprising a vector of tokens having the optimal sequence concatenation length 112. If the lengths, i.e., number, of the tokens for the text inputs do not quite match one of the combinations 120 of text input lengths, then the tokens from the text inputs may be padded so each of the text inputs match the text input lengths in one of the combinations 120.

The program binaries 110 the compiler 106 generates, for each of the combinations of text input lengths 120, include data sequencing programs 130, which load/store data a sequence concatenation from the scratchpad memories and feeds the sequence concatenation to processing elements (PE) and special function units (SFUs) on arrays on cores of the AI accelerator 200, and data processing programs 132, which define the set of computations executed on PE/SFUs on the incoming tokens in a from text inputs 114 concatenated in a sequence concatenation 128.

The memory 104 further includes an execution runtime 134 module which receives a sequence concatenation 128 and maps the tokens from the sequence concatenation 128 to the PEs and SFUs on the cores of the AI accelerator 200, and triggers and manages the execution of compute and data-transfer operations on the AI accelerator 200. The execution runtime 134 maps the sequence concatenation 128 through encoders and decoders of the transformer implemented in the AI accelerator 200 to provide NLP output, such as a classification of the text inputs 114 or an answer or response when the text inputs 114 comprise a question or request.

The arrows shown in FIG. 1 between the components and objects represent a data flow between the components.

In described embodiments, the inputs 114 are described as text inputs. In further embodiments, the inputs may comprise inputs from other language related domains, such as text, speech, multi-modal, e.g., text plus speech, etc. Further, the inputs may comprise inputs from any domain where the input comprises a sequence of tokens where the sequence length varies across inputs.

In described embodiments, the transformer is described as a language transformer. In further embodiments, the transformer may apply to other domains where the input is comprised of a sequence of tokens, and the sequence length varies across inputs.

Generally, program modules, such as the program components 106, 110, 122, 126, 130, 132, 134, among others, may comprise routines, programs, objects, components, logic, data structures, and so on that perform particular tasks or implement particular abstract data types. The program components and hardware devices of the inference server 100 and AI accelerator 200 may be implemented in one or more computer systems, where if they are implemented in multiple computer systems, then the computer systems may communicate over a network.

The program components 106, 110, 122, 126, 130, 132, 134, among others, may be accessed by a processor from memory to execute. Alternatively, some or all of the program components 106, 110, 122, 126, 130, 132, 134, among others, among others, may be implemented in separate hardware devices, such as Application Specific Integrated Circuit (ASIC) hardware devices and accelerator engines.

The functions described as performed by the program 106, 110, 122, 126, 130, 132, 134, among others, may be implemented as program code in fewer program modules than shown or implemented as program code throughout a greater number of program modules than shown.

The inference server 100 may comprise an enterprise class machine deployed in the cloud to process inference requests according to the AI accelerator 200 to generate output. Further, the inference server 100 may comprise an edge AI device deployed close to the user to process inference requests close to the user.

In described embodiments, the AI accelerator 200 may implement an NLP transformer, such as a transformer model architecture utilizing an attention mechanism to draw global dependencies between input and output. In certain embodiments, the AI accelerator 200 may implement a language transformer that relies entirely on self-attention to compute representations of input and output without using sequence aligned RNNs or convolution. The AI accelerator may also implement other types of language transformers, such as those using convolutional neural networks computing hidden representations in parallel for all input and output positions.

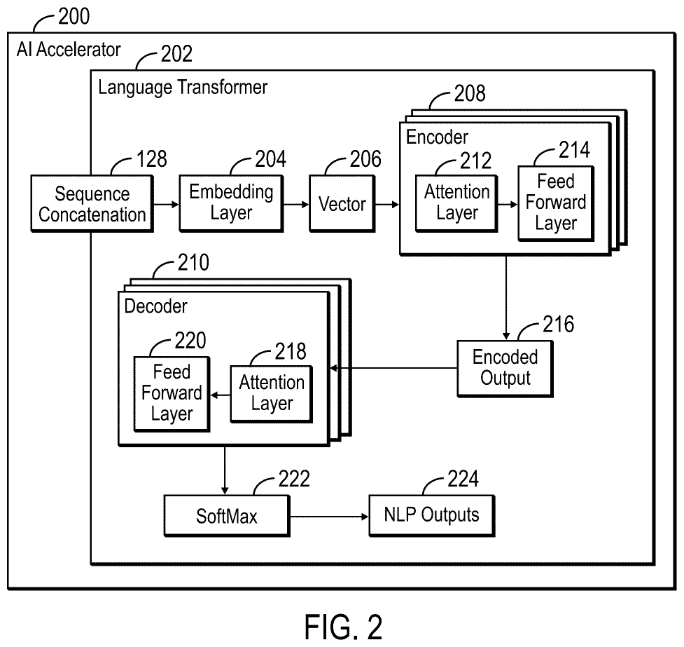

FIG. 2 illustrates an embodiment of the AI accelerator 200 architecture and dataflow in accordance with certain embodiments. The AI accelerator 200 is designed to provide enough compute performance to accommodate the maximum sustained system data bandwidth for long running systolic operations, while the performance of concurrently running virtual machines or partitions is not noticeably affected. Furthermore, the design matches the peak on-chip data bandwidth for short running elementwise or activation AI functions, and hence gets the maximum possible speed up for these functions.

In the implementation of FIG. 2, the AI accelerator 200 implements a language transformer 202, including an embedding layer 204 that converts the sequence concatenation 128 into a single concatenated sequence vector 206 with position encodings indicating a location in the text inputs 114 of the words represented by the tokens.

The language transformer 202 may include a stack of encoder layers 208 and stack of decoder layers 210. In the encoder stack 208, each encoder layer 208 may include two sub-layers, a multi-head attention layer 212 and a feed-forward network layer 214 to produce encoded output 216 provided to the decoder stack 210. The decoders 210 may also be comprised of multiple layers, each having one or more attention layers 218 and a feed-forward network 220 layer. The attention layers 212, 220 provide various calculations of attention scores representing a correlation between each pair of tokens in the tokenized text input 124, to relate the tokens for each word with the tokens for other words in the same text input. A SoftMax layer 222 receives decoded output and normalizes to a probability distribution, which can then be converted to the NLP outputs 224, such as a classification or text response to the text inputs, which may comprise questions or requests.

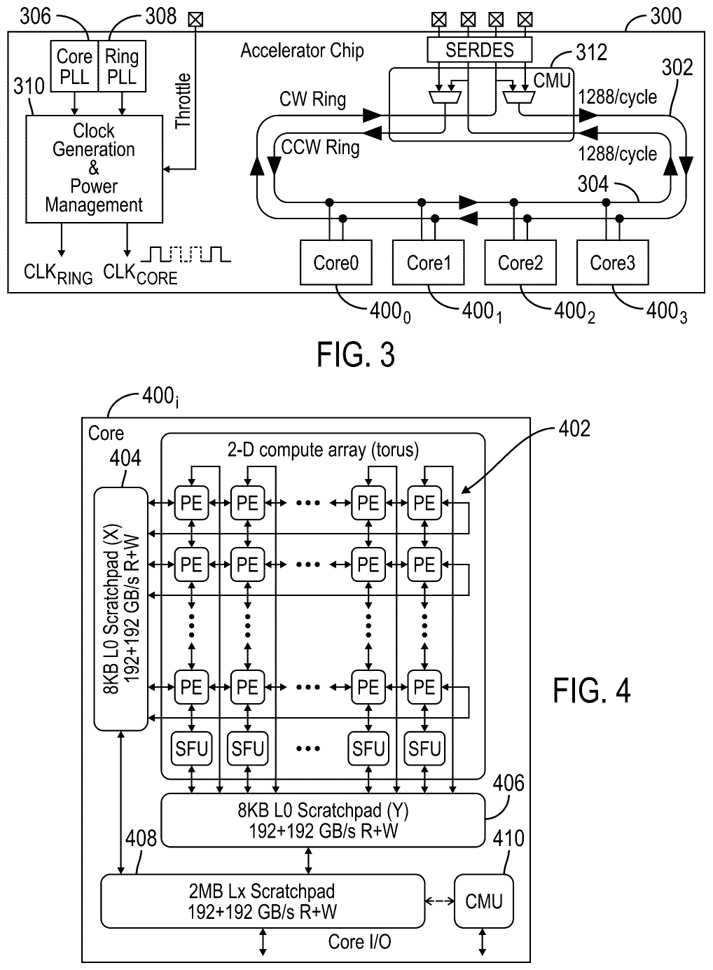

FIG. 3 provides an embodiment of an AI accelerator chip 300 on which the AI accelerator 200 log is implemented. The AI accelerator 300 chip has a plurality of cores 400₀, 400₁, 400₂, 400₃ connected to a bi-directional clockwise (CW) 302 and counter-clockwise (CCW) 304 rings. In additional implementations there may be more or fewer cores than shown. The ring and the cores operate in asynchronous clock domains with separate core 306 and ring 308 PLLs so as to optimally balance power/performance for compute and data movement. Cores 400₀, 400₁, 400₂, 400₃ communicate with each other and with memory using the memory/neighbor interface and the ring interface unit across the asynchronous boundary. To enable scaling to a larger system, the rings are connected through a chip management unit (CMU) 312 that can either close the rings within a single accelerator chip or connect multiple chips to form manycore systems. The Accelerator AI chip 300 also includes power management 310 to implement the power for the chip 300. In alternative embodiments, alternative chip architectures that differ from FIG. 3 may be used to implement and interconnect the cores 400₀, 400₁, 400₂, 400₃. In additional implementations there may be more or fewer cores than shown.

FIG. 4 illustrates an embodiment of a core 400ᵢ, such as one of the cores 400₀, 400₁, 400₂, 400₃, on AI accelerator 300. A compute array 402 is arranged in a 2-dimensional torus of processing elements (PEs). Each PE comprises a single instruction multiple data (SIMD) engine comprising a tiny core, including an instruction buffer, fetch/decode stage, register file, floating-point execution units, and binary and ternary Arithmetic Logic Units (ALUs), and fabric links to and from the neighboring PEs. The execution units handle basic operations such as multiply-add with estimation for many non-linear functions such as square root or reciprocal. The bottom row of the compute array is a set of special function units (SFUs) that are similar to the PEs, but with support for higher-precision 32-bit FP math and datatype conversion between 16-bit and 32-bit. In one implementation, the array 402 may comprise 32 PEs or SFUs horizontally by 16 PEs and 1 SFU vertically. The arrays 402 on the cores 400; may implement the components in FIG. 2, such as the embedding layer 204, encoder stack 208, decoder stack 210, attention layers 212, 220, feed forward layers 214, 220, SoftMax 222, etc.

A concatenated sequence 128 arrives into the compute array 402 from a two-level scratchpad. Two 8 KB LO scratch pads 404 and 406 are positioned along different dimensions of the torus array 402, backed up by a shared 2 MB scratchpad 408. In a weight stationary approach, the weights of the neural network are stored in the local registers, but move input data and partial sums through the fabric and scratchpads. An output stationary approach moves the inputs, weights, and attention values used in attention calculations, but keeps the partial sums in the local register file. A row stationary approach exploits locality in multiple dimensions, by mapping a row of weights (e.g., one dimension of a convolution) and a row of inputs to each PE, and then combining together different results to generate the partial sums. A chip management unit (CMU) 410 may comprise the CMU 312 (FIG. 3) to connect a core to other cores in the AI accelerator 200. Further, one core may include multiple arrays 402.

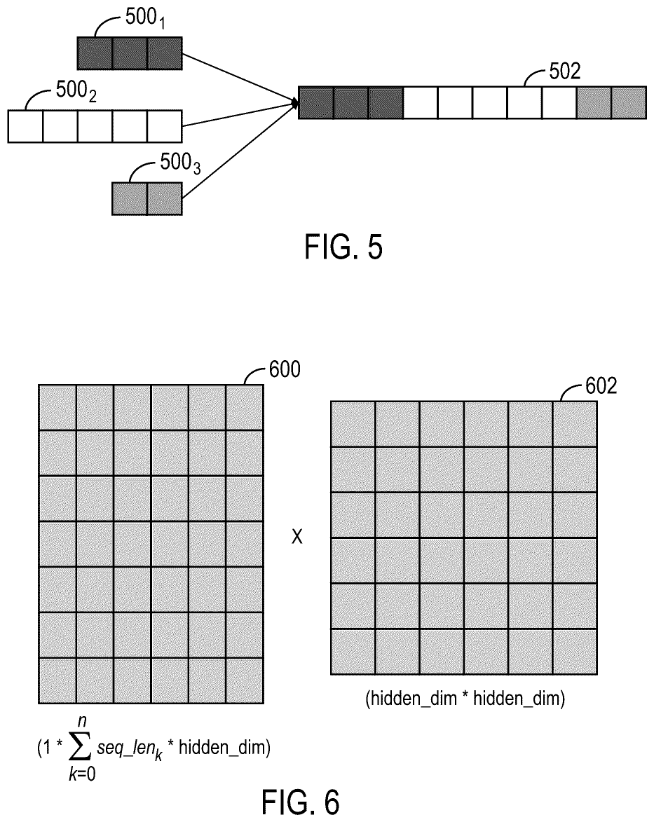

FIG. 5 illustrates an example of how the concatenator 126 may concatenate token sequences 500₁, 500₂, 500₃ from the text inputs 114 into a single sequence concatenation 502, such as concatenation 128, which may comprise a single vector.

FIG. 6 illustrates an example of a matrix 600 having dimensions of a sum of the sequence lengths of the tokens from k text inputs and a dimensions of a hidden layer matrix 602 comprising weights and biases. Multiplication of matrix 600 with the sequence concatenation 128 with the hidden layer matrix 602 performs a sequence-parallel computation on the sequence concatenation 128 in the language transformer 202, such as in computations not involving interacting computations of tokens within text input for attention calculations. The values of the sequence concatenation 128 are repeatedly transformed while transitioning through the language transformer 202 by applying matrix multiplication with hidden dimension matrices in the layers of the encoders and decoders.

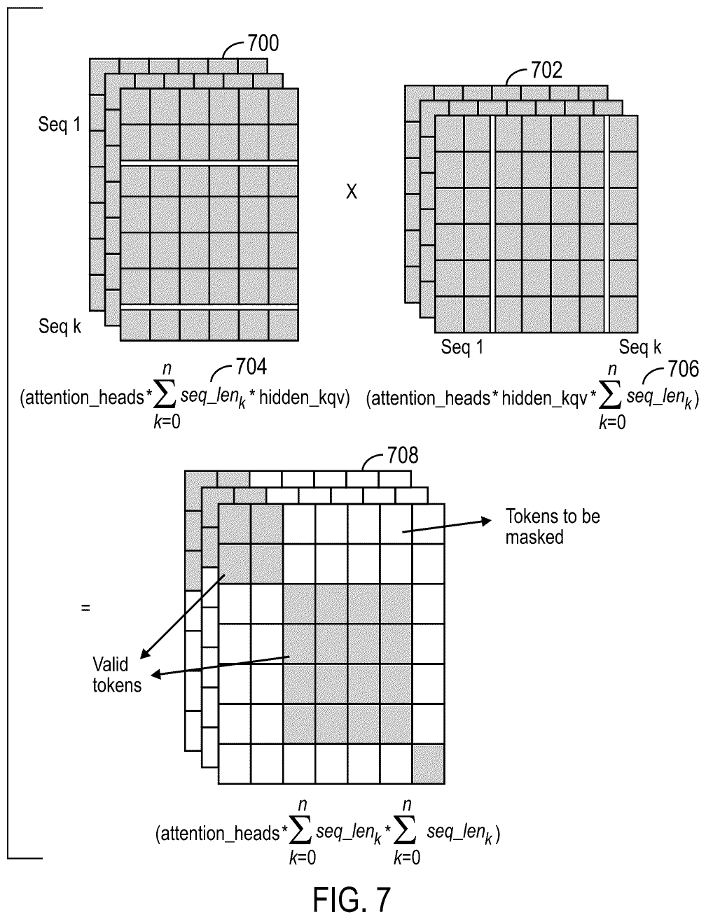

FIG. 7 illustrates matrices used in the attention computation at the attention layers 212, 218. The matrices 700 comprise matrices for different heads or attention computations. The matrices 700 have dimensions of the sequence-concatenation length and a dimension of the attention parameters, such a query (q), key (k), and value (v), to further process attention scores of the tokens in the sequence concatenation 128. The q, k, and v values may be generated by the compiler 106 when creating the program binaries 110 that program the k, q, and v parameters in the matrices 700, 702 to use in matrix multiplication in the attention layers. The sum of the sequence lengths 704, 706 for k text inputs is the sum of the sequence length of the tokens in the text inputs.

The matrices 700 and 702 are multiplied as part of the attention layer processing to produce matrix 708 having correlation scores between the tokens of text input 114. The valid cells comprise attention scores calculated for pairs of tokens from one text input 114, e.g., words from the same sentence, and the tokens to be masked comprise cells corresponding to pairs of tokens between text inputs, e.g., words from different sentences, where correlation is not to be calculated. In one embodiment, matrices 708 having the attention heads for attention scores of the tokens may have empty cells for the tokens to be masked or comprise a sparse matrix without cells for attention scores between tokens from different text inputs 114. An attention mask may be maintained in the program binaries 110, for a combination of input lengths, indicating cells in the matrix that do not have attention scores so that these cells in the attention matrix are not involved in computations during transformer operations.

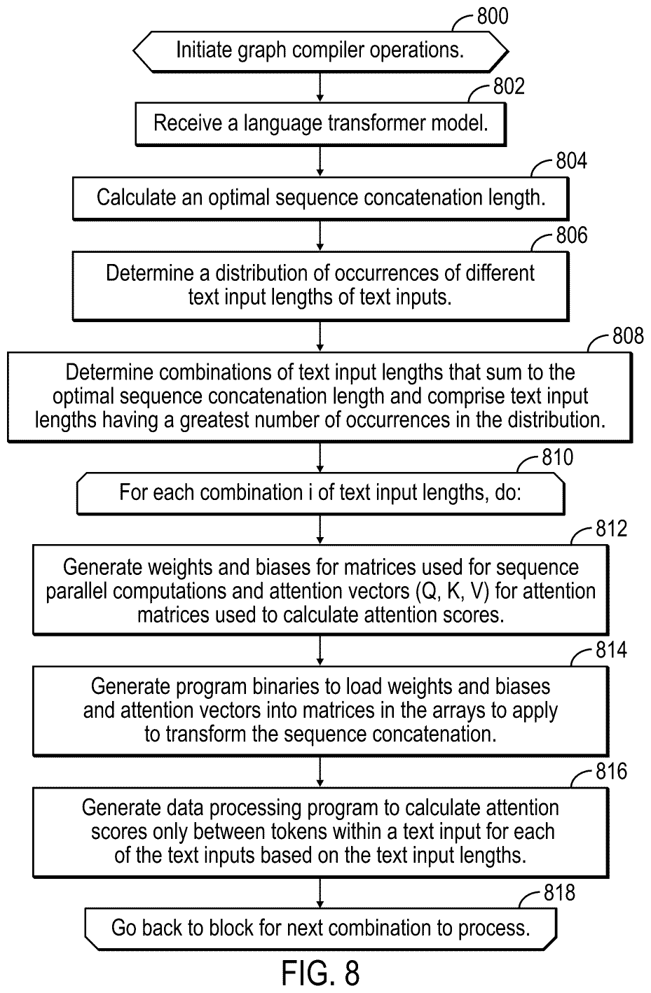

FIG. 8 illustrates an embodiment of graph compiler 106 operations to compile program binaries 110 for the language transformer 108 to be available for immediate use to process text inputs 114. Upon initiating (at block 800) compilation operations, the graph compiler 106 receives (at block 802) a graph representation of a language transformer neural network 108. The compiler 106 calculates (at block 804) an optimal sequence concatenation length 112, comprising a maximum number of tokens that when processed has a latency less than a required latency. The compiler 106 determines (at block 806) a distribution of occurrences of different text input lengths, i.e., number of tokens, of text inputs. This may be a distribution of text input lengths from a training set or that is gathered during operations of the deployed language transformer 202. A determination is then made (at block 808) of combinations of text input lengths 120 that sum to the optimal sequence concatenation length 116 and comprise text input lengths having a greatest number of occurrences in the distribution, i.e., the most commonly submitted text input lengths for inference. The number of combinations 120 determined may be limited by available space to store the program binaries 110, so that the number of combinations 120 will not increase beyond the available space needed to store the program binaries for the combinations.

For each combination i of text input lengths of the combinations 120, a loop of operations at blocks 810 through 818 is performed. At block 812, the compiler 106 generates weights and biases for matrices used for sequence parallel-computations and attention vectors (Q. K. V) for attention matrices used to calculate attention scores. The compiler 106 generates (at block 814) program binaries 110 to load the generated weights and biases and attention vectors into matrices into the PEs and SF in the arrays 402 of the cores 400; to apply to transform the sequence concatenation. The compiler 106 further generates (at block 816) data processing programs 130 in the program binaries 110 to calculate attention scores only between tokens within a text input for each of the text inputs 114 based on the text input lengths for the combination i.

With the embodiment of FIG. 8, the program binaries 110 to process the sequence concatenation for different combinations 120 of text input lengths are calculated to allow processing of the sequence concatenation having tokens for text inputs of different lengths. Further, the weights, biases, and attention values loaded into the matrices may be reused for different of the combinations 120 of text input lengths for the same sequence concatenation length. This improves efficiency by not having to reload the weights, balances and attention vectors every time a sequence concatenation 128 is processed for different text input lengths. This allows sequence concatenations of the optimal length 112 having tokens for different text input lengths to be processed without delays to load the weights, biases, and attention vectors for the different text input lengths into the PEs and SFUs because the weights, biases and attention vectors are retained and used for different combinations of text input lengths in the sequence concatenation. Further, the program binaries 110 for different combinations 120 vary to allow for calculation of attention scores for different text input lengths so attention scores are not calculated for tokens from different text inputs. Yet further, efficiency is improved because the inference input is not padded, thereby saving computations on the padded tokens

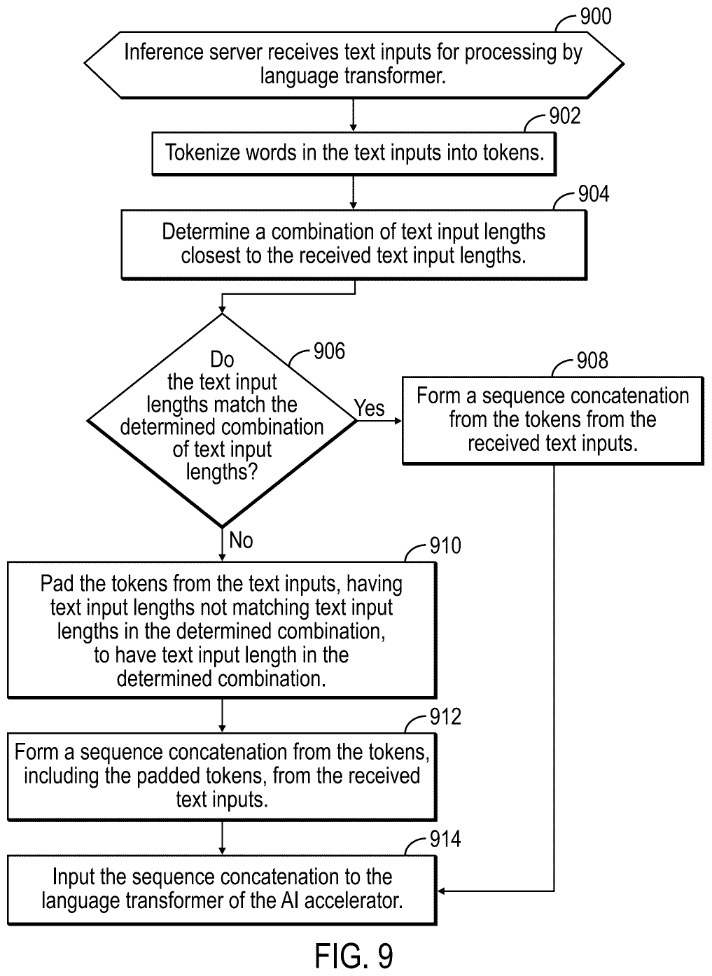

FIG. 9 illustrates an embodiment of operations performed by the tokenizer 122 and concatenator 126 to generate the sequence concatenation 128 to input to the AI accelerator 200. Upon the inference server 100 receiving (at block 900) text inputs 114 to batch for processing by the language transformer 202, the tokenizer 122 tokenizes (at block 902) words in the text inputs 114. A combination of text input lengths from the combination 120 closest to the received text input lengths is determined (at block 904). If (at block 906) the text input 114 token lengths match the determined combination of text input lengths 120, then the concatenator 126 forms (at block 908) a sequence concatenation 128 from the tokens from the received text inputs 114. If (at block 906) the text input 114 token lengths do not match the determined combination of text input token lengths, then the concatenator 126 pads (at block 910) the tokens from the text inputs 114, having text input lengths not matching text input lengths in the determined combination, to have a text input length matching the length in the determined combination. The concatenator 126 forms (at block 912) a sequence concatenation 128 from the tokens, including the padded tokens, from the received text inputs 114. From block 908 or 912, the sequence concatenation 128 is inputted (at block 914) to the language transformer 202 of the AI accelerator 200.

With the embodiment of FIG. 9, text inputs 114 received having varying text input lengths may be added to a sequence concatenation 128 having an optimal sequence concatenation length 112 with no or minimized padding to avoid wasted computations on padded portions of the sequence concatenation 128.

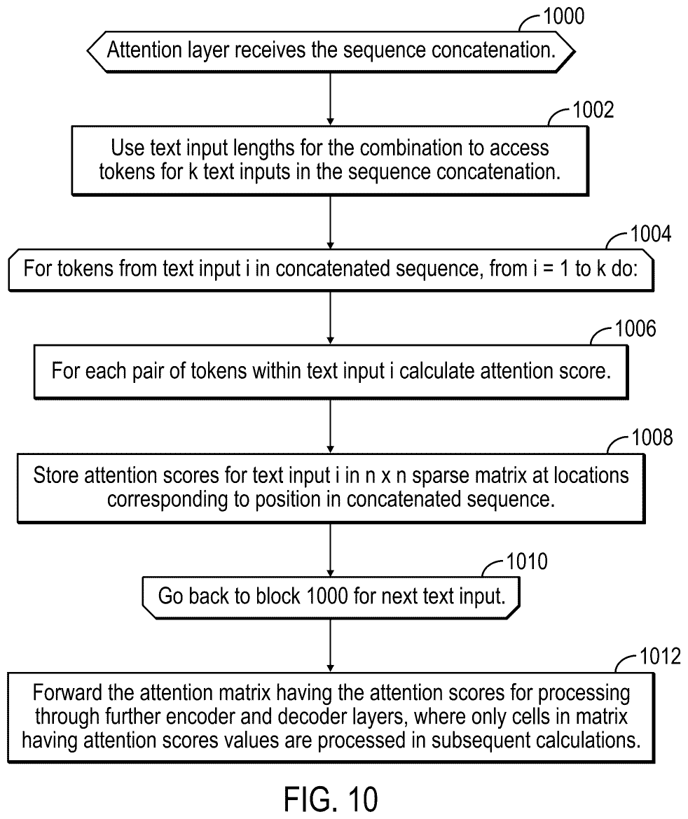

FIG. 10 illustrates an embodiment of operations performed by the program binaries 110 to have specific code to calculate attention scores based on the text input lengths of the tokens from text inputs in the sequence concatenation 128 to calculate attentions only for tokens from the same text input and not for tokens from different text inputs. Upon the attention layer 212 receiving (at block 1000) the sequence concatenation 128, the input lengths specified for the combination 120 used to form the sequence concatenation are used (at block 1002) to access tokens for the k text inputs in the sequence concatenation 128. A loop of operations is performed from blocks 1004 through 1010 for tokens from each text input i in the concatenated sequence 128, for text inputs 1 . . . k, where there are k text inputs in the concatenated sequence 128. At block 1006, for each pair of tokens within text input i, an attention score is calculated using attention analysis. The calculated attention scores are stored (at block 1008) in an n x n sparse matrix, where n is the number of tokens in the sequence concatenation 128, at locations corresponding to their position in the concatenated sequence 128. The attention matrix having the attention scores is forwarded (at block 1012) through further encoder 208 and decoder 210 layers, where only cells in the attention matrix having attention scores values are processed in subsequent calculations.

With the embodiment of FIG. 10, attention matrix computations are optimized by limiting calculations to only those cells having attention scores. This allows for efficient processing of the sequence concatenation 128 in the accelerator 200.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

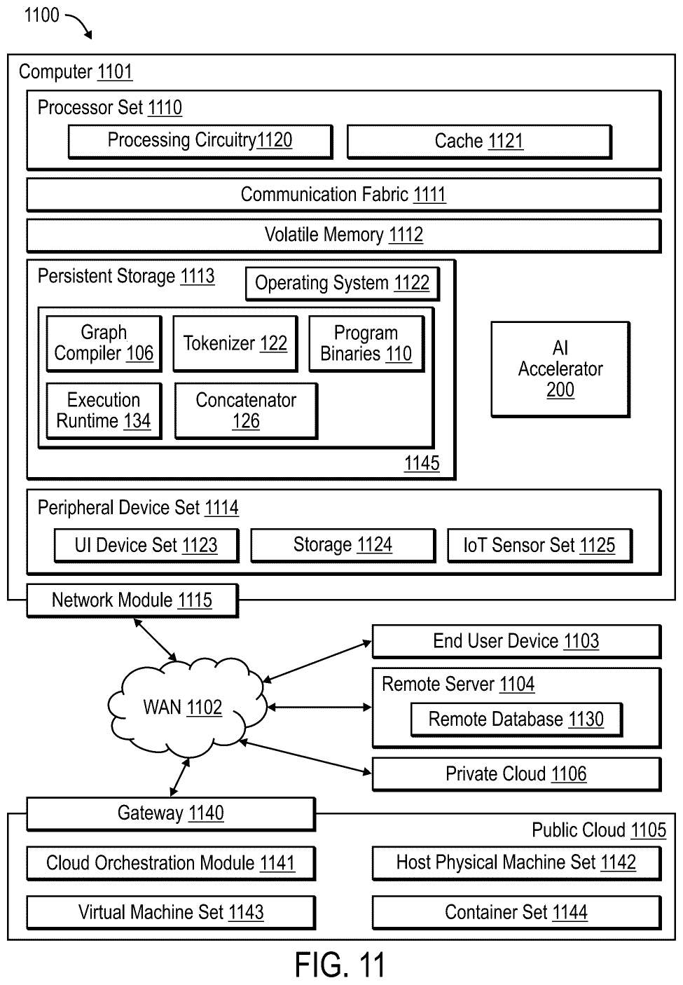

With respect to FIG. 11, computing environment 1100 contains an example of an environment for the execution of at least some of the computer code involved in performing the inventive methods to generate program binaries for a language transformer to process a sequence concatenation having text inputs of different text input lengths, including block 1145, which includes the graph compiler to generate the program binaries 110 to program the AI accelerator 200, tokenizer 122, concatenator 126 and execution runtime 134 of FIG. 1. In addition to block 1145, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1145 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The letter designators, such as i, j, k, n, are used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A computer program product for generating program binaries to program a transformer in an array of processing elements in an accelerator, the computer program product comprising a computer readable storage medium having computer readable program code embodied therein that is executable to perform operations, the operations comprising:
selecting a sequence concatenation length of a sequence concatenation of concatenated tokens from inputs to process in the accelerator;
determining combinations of input lengths, wherein each combination of input lengths sum to the sequence concatenation length;
processing a representation of a transformer to generate program binaries for each combination of input lengths of the combinations, wherein the program binaries, for a given combination of input lengths of the combinations, program the accelerator to decompose tokens of inputs in the sequence concatenation according to the input lengths in the given combination and compute attention scores between tokens within each input of the inputs in the sequence concatenation; and
executing program binaries, for a combination of input lengths, to process a sequence concatenation of received inputs, having input lengths of the combination, to generate outputs for tokens in the processed sequence concatenation.

2. The computer program product of claim 1, wherein the selecting the sequence concatenation length comprises:
determining an optimal sequence concatenation length that when input to the transformer maximizes throughput within a latency constraint, wherein the selected sequence concatenation length comprises the optimal sequence concatenation length.

3. The computer program product of claim 1, wherein the determining the combinations of input lengths comprises:
determining a distribution of occurrences of different input lengths of received inputs, wherein the combinations of input lengths in the combinations comprises the input lengths having a greatest number of occurrences in the distribution of occurrences.

4. The computer program product of claim 1, wherein the operations further comprise:
forming the sequence concatenation from a plurality of tokens from the received inputs, for processing by the transformer, having input lengths summing to the sequence concatenation length.

5. The computer program product of claim 1, wherein the operations further comprise:
in response to the input lengths of the received inputs not comprising input lengths in one of the combinations of input lengths, performing:
determining a combination of input lengths closest to the input lengths of the received inputs;
padding the received inputs to have the input lengths of the determined combination; and
forming the sequence concatenation from the padded received inputs, having input lengths summing to the sequence concatenation length.

6. The computer program product of claim 1, wherein the operations further comprise:
determining a combination having input lengths corresponding to input lengths of tokens in the received inputs to include in the sequence concatenation;
determining program binaries of the program binaries generated for the determined combination; and
executing the determined program binaries to control the transformer to transform the tokens in the received inputs in the sequence concatenation to generate the outputs for the received inputs in the sequence concatenation.

7. The computer program product of claim 1, wherein the program binaries for the combinations when executed perform:
programming the transformer to perform sequence-parallel matrix multiplications on the sequence concatenation as part of encoding and decoding of the sequence concatenation.

8. The computer program product of claim 1, wherein the accelerator is programmed to decompose the tokens in the sequence concatenation to compute attention scores within each of the received inputs by:
performing attention analysis of the sequence concatenation of tokens to calculate attention scores between pairs of tokens within each of the received inputs, wherein attention scores are not determined between tokens from different received inputs;
forming an attention matrix, for the sequence concatenation, having the calculated attention scores for pairs of tokens within the received inputs of the sequence concatenation; and
applying the attention matrix in matrix multiplications to produce the outputs for the received inputs.

9. The computer program product of claim 8, wherein the attention matrix comprises a sparse matrix.

10. The computer program product of claim 8, wherein the operations further comprise:
generating an attention mask for the attention matrix indicating cells in the attention matrix having the attention scores and cells not having attention scores, wherein the attention mask is used to process only cells having calculated attention scores.

11. A system for generating program binaries to program a transformer in an array of processing elements in an accelerator, comprising:
an accelerator;
a processor; and
a computer readable storage medium having computer readable program code embodied therein that is when executed by the processor performs operations the operations comprising:
selecting a sequence concatenation length of a sequence concatenation of concatenated tokens from inputs to process in the accelerator;
determining combinations of input lengths, wherein each combination of input lengths sum to the sequence concatenation length;
processing a representation of a transformer to generate program binaries for each combination of input lengths of the combinations, wherein the program binaries, for a given combination of input lengths of the combinations, program the accelerator to decompose tokens of inputs in the sequence concatenation according to the input lengths in the given combination and compute attention scores between tokens within each input of the inputs in the sequence concatenation; and
executing program binaries, for a combination of input lengths, to process a sequence concatenation of received inputs, having input lengths of the combination, to generate outputs for tokens in the processed sequence concatenation.

12. The system of claim 11, wherein the operations further comprise:
forming the sequence concatenation from a plurality of tokens from received inputs, for processing by the transformer, having input lengths summing to the sequence concatenation length.

13. The system of claim 11, wherein the operations further comprise:
in response to the input lengths of received inputs not comprising input lengths in one of the combinations of input lengths, performing:
determining a combination of input lengths closest to the input lengths of the received inputs;
padding the received inputs to have the input lengths of the determined combination; and
forming the sequence concatenation from the padded received inputs, having input lengths summing to the sequence concatenation length.

14. The system of claim 11, wherein the operations further comprise:
determining a combination having input lengths corresponding to input lengths of tokens in the received inputs to include in the sequence concatenation;
determining program binaries of the program binaries generated for the determined combination; and
executing the determined program binaries to control the transformer to transform the tokens in the received inputs in the sequence concatenation to generate the outputs for the received inputs in the sequence concatenation.

15. The system of claim 11, wherein the accelerator is programmed to decompose the tokens in the sequence concatenation to compute attention scores within each of the received inputs by:
performing attention analysis of the sequence concatenation of tokens to calculate attention scores between pairs of tokens within each of the received inputs, wherein attention scores are not determined between tokens from different received inputs;
forming an attention matrix, for the sequence concatenation, having the calculated attention scores for pairs of tokens within the received inputs of the sequence concatenation; and
applying the attention matrix in matrix multiplications to produce the outputs for the received inputs.

16. A method for generating program binaries to program a transformer in an array of processing elements in an accelerator, comprising:
selecting a sequence concatenation length of a sequence concatenation of concatenated tokens from inputs to process in the accelerator;
determining combinations of input lengths, wherein each combination of input lengths sum to the sequence concatenation length;
processing a representation of a transformer to generate program binaries for each combination of input lengths of the combinations, wherein the program binaries, for a given combination of input lengths of the combinations, program the accelerator to decompose tokens of inputs in the sequence concatenation according to the input lengths in the given combination and compute attention scores between tokens within each input of the inputs in the sequence concatenation; and
executing program binaries, for a combination of input lengths, to process a sequence concatenation of received inputs, having input lengths of the combination, to generate outputs for tokens in the processed sequence concatenation.

17. The method of claim 16, further comprising:
forming the sequence concatenation from a plurality of tokens from the received inputs, for processing by the transformer, having input lengths summing to the sequence concatenation length.

18. The method of claim 16, further comprising:
in response to the input lengths of received inputs not comprising input lengths in one of the combinations of input lengths, performing:
determining a combination of input lengths closest to the input lengths of the received inputs;
padding the received inputs to have the input lengths of the determined combination; and
forming the sequence concatenation from the padded received inputs, having input lengths summing to the sequence concatenation length.

19. The method of claim 16, further comprising:
determining a combination having input lengths corresponding to input lengths of tokens in the received inputs to include in the sequence concatenation;
determining program binaries of the program binaries generated for the determined combination; and
executing the determined program binaries to control the transformer to transform the tokens in the received inputs in the sequence concatenation to generate the outputs for the received inputs in the sequence concatenation.

20. The method of claim 16, wherein the accelerator is programmed to decompose the tokens in the sequence concatenation to compute attention scores within each of the received inputs by:
performing attention analysis of the sequence concatenation of tokens to calculate attention scores between pairs of tokens within each of the received inputs, wherein attention scores are not determined between tokens from different received inputs;
forming an attention matrix, for the sequence concatenation, having the calculated attention scores for pairs of tokens within the received inputs of the sequence concatenation; and
applying the attention matrix in matrix multiplications to produce the outputs for the received inputs.
